(19) United States
(12) Patent Application Publication
(10) Pub. No.: US 2016/0088355 A1
(43) Pub. Date: Mar. 24, 2016

(54) APPARATUS AND METHOD FOR PROCESSING IMAGE AND COMPUTER READABLE RECORDING MEDIUM

(71) Applicant: SAMSUNG ELECTRONICS CO., LTD., Suwon-si (KR)

(72) Inventors: Olha Zubarieva, Hwaseong-si (KR); Andrii LIUBONKO, Vinnytsia (UA); Igor KUZMANENKO, Kyiv (UA); Tetiana IGNATOVA, Krasnoarmiysk (UA); Volodymyr MANILO, Sadky (UA)

(73) Assignee: SAMSUNG ELECTRONICS CO., LTD., Suwon-si (KR)

(21) Appl. No.: 14/858,380

(22) Filed: Sep. 18, 2015

(30) Foreign Application Priority Data
Sep. 19, 2014 (KR) 10-2014-0124959

(51) Int. Cl. H04N 21/475; G06K 9/62; G06K 9/66; H04N 21/466; H04N 21/258; H04N 21/2668; H04N 21/45; G06K 9/00; H04N 21/25

(52) U.S. Cl. CPC H04N 21/4755; G06K 9/00744; G06K 9/00718; G06K 9/6256; G06K 9/66; G06K 9/6218; H04N 21/251; H04N 21/25891; H04N 21/2668; H04N 21/4532; H04N 21/4662

(57) ABSTRACT

An image processing apparatus, an image processing method, and a computer readable recording medium are provided. The image processing apparatus includes a communication interface unit configured to receive video content, and a genre conceiver configured to extract feature information of an arbitrary frame of the received video content and to conceive a genre of an updated frame with reference to the extracted feature information in response to the frame being updated.

### CROSS-REFERENCE TO RELATED APPLICATIONS

This application claims priority from Korean Patent Application No. 10-2014-0124959, filed on Sep. 19, 2014, in the Korean Intellectual Property Office, the disclosure of which is incorporated herein by reference in its entirety.

### BACKGROUND

1. Field

Apparatuses and methods consistent with the present embodiments relate to an image processing apparatus, an image processing method, and a computer readable recording medium, and more particularly, to an image processing apparatus, an image processing method, and a computer readable recording medium, for conceiving a video genre in real time in an apparatus, for example, a TV, a set-top box (STB), and a cellular phone.

2. Description of the Related Art

Many academic journals have disclosed problems associated with genre conception. Ionescu, etc. have done research on audio/video modalities in order to overcome an automatic genre labeling issue for data mining. The adopted features include audio features with a block level, temporary features of video, structural features thereof, and color features (low-level color descriptors as well as more complex features based on human color recognition). The experiments handle binary classification and multi-class classification of one genre at one time using K-nearest neighbors, a support vector machine (SVM) with an approximation kernel, and linear discriminant analysis (LDA) for binary classification and multi-class SVM for multi-class classification. The most satisfactory operation for binary classification is varied according to genre but is changed between 74 to 99% and improved with an SVM. In terms of real time processing, this approach has a limit in that all video contents are assumed to belong to the same genre. Under this assumption, it is difficult to classify heterogeneous content in both learning and classification (including other types of genres). 91 hours of total video are used to train and test SVM models.

Ekenel, etc. use audio/video forms formed by further adding more complex cognitive and structural features. The audio-visual features are not particularly selected for the task of genre conception, are re-used to detect high level of features, and include color, texture, and audio descriptors. Classification is performed with SVM models that are particularly trained for each feature and each genre. Outputs of all models are combined and a final decision is determined according to majority voting. This strategy attains an accuracy of 92 to 99.6% according to a data set. One obvious advantage of this approach its all over use of extracted features for overcoming other tasks. Accordingly, a step of extracting a separated feature is omitted (or is reduced due to use of additional cognitive and structural features). High classification accuracy is possible with other added features. Results are still dependent upon a data set and the data (92% compared with 99 to 99.6% accuracy achieved according to other data sets) are deemed to be reduced in terms of accuracy of Youtube data. Similarly to the previous test, the system aims for non-real time processing and thus uses features obtained by considering data from all video content at one time.

Glasberg, etc. propose binary set classifiers that use audio and visual features and combination thereof in order to obtain a decision in the case of multi-class genre classification under a condition close to a real-time condition. In classification for sets of features and binary classification, most appropriate combinations are assumed for each type of video contents and separated and selected for each genre. This strategy reduces complexity and processing time for calculation but some of the selected features are not rapidly calculated. Although this approach ensures an average accuracy of 92 to 98% (according to genre), wrong negative estimations are rather high and recall is changed to 73 to 94%. 5 hours of total video are used to train and test the classifier.

Yuan, etc. emphasize issues of hierarchical video genre classification by labeling video items as sports and movie video items that are subdivided as News, music, sports, advertisement, and movie genres and narrower sub genre. In order to obtain a goal of multi-class genre classification, they select a binary set SVM classifier that is aligned in the form of a binary tree. Localized and global optimum SVM binary trees are dynamically established during training. In this research, only visual features are extracted from a video stream in order to form 10 dimension feature vectors and this exhibits an average accuracy of 87% by combining the features in that accuracy of movie genre classification (76%) is degraded and the feature of that high performance is obtained for sports genre (almost 95%). This approach concentrates on packet video processing due to the nature of used features that are not capable of being applied to real-time genre conception.

Rouvier, etc. overcome tasks of real-time genre conception using only audio forms and compare results provided by the system with an actual human behavior. 7 genres are classified by a genre-dependent Gaussian mixture model-a general purpose background model with factor analysis as a classifier-. This classification uses three acoustic features, that is, perceptual linear prediction (PLP), Rasta-PLP, and MFCC. The proposed system surpasses humans upon being requested to classify a 5-second video that facilitates a highest accuracy of 53% and reaches 79% in the case of 20 seconds of analysis.

However, these conventional technologies do not have an ability of operating in a real-time mode, an ability of operating with compression video as well as non-compression video, an ability of using other approaching methods with respect to training of offline and on line, and so on, and have many issues associated with use of only visual features (audio features are not used) and issues associated with use of other groups, such as color, motion, and edges.

### SUMMARY

Additional aspects and/or advantages will be set forth in part in the description which follows and, in part, will be apparent from the description, or may be learned by practice of the embodiments.

Exemplary embodiments overcome the above disadvantages and other disadvantages not described above. Also, the embodiments arenot required to overcome the disadvantages described above, and a particular exemplary embodiment of may not overcome any of the problems described above.

The embodiments provide an image processing apparatus, an image processing method, and a computer readable recording medium, for conceiving a video genre in real time in an apparatus, for example, a TV, a set-top box (STB), and a cellular phone.

According to an aspect of the embodiments, an image processing apparatus includes a communication interface unit configured to receive video content, and a genre conceiver configured to extract feature information of an arbitrary frame of the received video content and to conceive a genre of an updated frame with reference to the extracted feature information in response to the frame being updated.

The image processing apparatus may further include a user interface unit configured to set at least one user information item for searching for, storing, skipping, and watch-limiting data corresponding to the conceived genre, wherein the genre conceiver processes the video content based on the set user information and the conceived genre.

The genre conceiver may conceive the genre based on at least one feature information item of color, texture, motion feature and edge feature of the frame, and textural and object content present in a video frame.

The genre conceiver may include a shot detector configured to check whether there is shot break between a previous frame and a current frame and, in response to shot break occurring as the check result, stores feature information of the current frame.

The genre conceiver may store the feature information of the current frame at a frequency corresponding to a predetermined period of time when there is no shot break between the current frame and the previous frame.

The image processing apparatus may further include a storage unit, wherein the genre conceiver may detect feature information of the updated frame, separates the detected feature information, and stores the feature information in the storage unit.

The genre conceiver may include a plurality of feature information detectors configured to detect a plurality of feature information items with different features, and the plurality of feature information detectors may include a model selected via a training process for searching for a model appropriate for the genre detection.

The genre conceiver may be operated in a training mode for the training process, may process data instances of a video data set of the video content via principle component analysis (PCA) in the training mode, and may cluster the data instances using a K-means scheme for representative instances for model training to search for the appropriate model.

The image processing apparatus may further include a video processor configured to enhance video of the conceived genre.

The image processing apparatus may further include a tuner configured to automatically skip a channel until a channel of the conceived genre is retrieved.

The image processing apparatus may further include a controller configured to limiting recording or watching an image of the conceived genre.

According to another aspect of the embodiments, an image processing method includes receiving video content, extracting feature information of an arbitrary frame of the received video content, and conceiving a genre of an updated frame with reference to the extracted feature information in response to the frame being updated.

The image processing method may further include setting at least one user information item for searching for, storing, skipping, and watch-limiting data corresponding to the conceived genre, and processing the video content based on the set user information and the conceived genre.

The conceiving may include conceiving the genre based on at least one feature information item of color, texture, motion feature and edge feature of the frame, and textural and object content present in a video frame.

The conceiving may include checking whether there is shot break between a previous frame and a current frame, and in response to shot break occurring as the check result, storing feature information of the current frame.

The conceiving may include storing the feature information of the current frame at a frequency corresponding to a predetermined period of time when there is no shot break between the current frame and the previous frame.

The conceiving may include detecting feature information of the updated frame, and separating the detected feature information and storing the feature information in a storage unit.

The conceiving may include detecting a plurality of feature information items with different features, and the plurality of detected feature information items may be detected by embodying a model selected via a training process for searching for a model appropriate for the genre detection.

The conceiving may be operated in a training mode for the training process, and may include processing data instances of a video data set of the video content via principle component analysis (PCA) in the training mode, and clustering the data instances using a K-means scheme for representative instances for model training to search for the appropriate model.

According to another aspect of the embodiments, a computer readable recording medium having a program for executing an image processing method, the method including receiving video content, extracting feature information of an arbitrary frame of the received video content, and conceiving a genre of an updated frame with reference to the extracted feature information in response to the frame being updated.

### BRIEF DESCRIPTION OF THE DRAWINGS

The above and/or other aspects of the embodiments will be more apparent by describing certain exemplary embodiments with reference to the accompanying drawings, in which:

FIG. 1 is a diagram illustrating a genre conception system according to an embodiment;

FIG. 2 is a diagram for explanation of various genres;

FIG. 3 is a block diagram illustrating the image processing apparatus of FIG. 1;

FIG. 4 is a block diagram illustrating another structure of the image processing apparatus of FIG. 1;

FIG. 5 is a flowchart illustrating an image processing method according to an embodiment;

FIG. 6 is a flowchart illustrating an image processing method according to another embodiment;

FIG. 7 is a flowchart illustrating the feature extraction process of FIG. 6 in more detail; and

FIGS. 8A and 8B are flowcharts illustrating detailed operations of the feature extraction modules illustrated in FIG. 7.

### DETAILED DESCRIPTION

Reference will now be made in detail to the embodiments, examples of which are illustrated in the accompanying drawings, wherein like reference numerals refer to the like elements throughout. The embodiments are described below by referring to the figures.

Reference will now be made in detail to the exemplary embodiments with reference to the accompanying drawings.

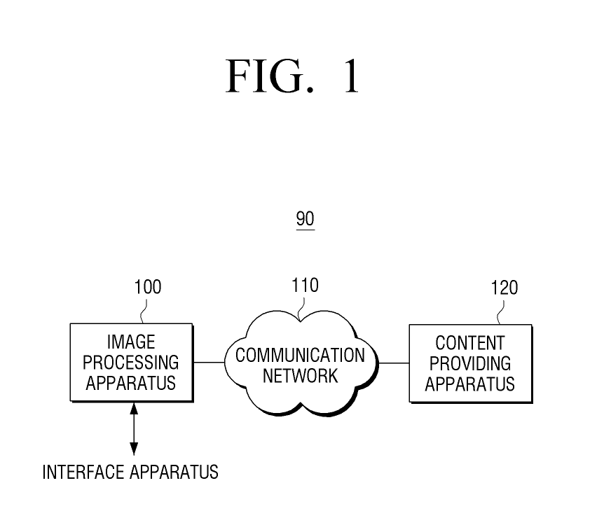

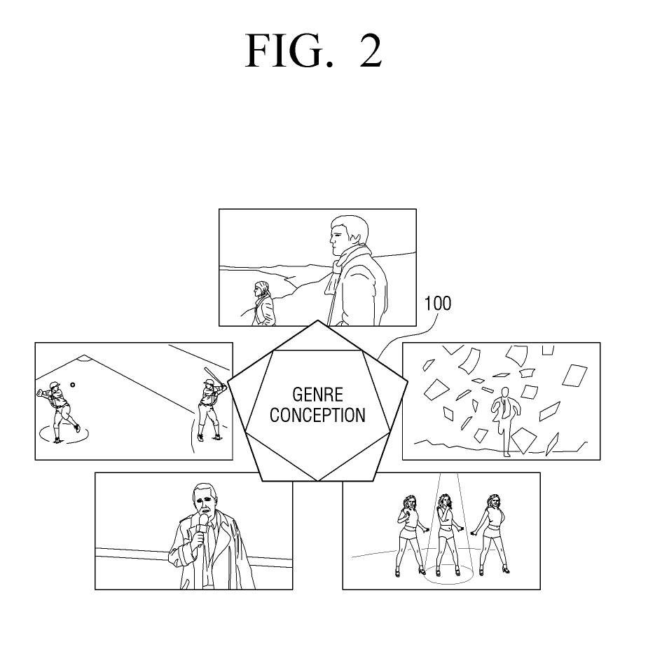

FIG. 1 is a diagram illustrating a genre conception system 90 according to an embodiment. FIG. 2 is a diagram for an explanation of various genres.

As illustrated in FIG. 1, the genre conception system 90 may include some or all of an image processing apparatus 100, a communication network 110, and a content providing apparatus 120 and may further include an interface apparatus that is operatively associated with the image processing apparatus 100.

Here, the expression ‘inclusion of some or all’ means that some components such as the communication network 110 and the content providing apparatus 120 are omitted and the image processing apparatus 100 alone performs a genre conception operation or are operatively associated with an interface apparatus, and it is assumed that the genre conception system 90 includes all the components to allow for a sufficient understanding of the embodiments.

The image processing apparatus 100 according to an embodiment may include various apparatuses, such as a television (TV), a set-top box, a cellular phone, a personal digital assistance (PDA), a video cassette recorder (VCR), a blue-ray disk (BD) player, a tablet personal computer (PC), an MP3 player, and so on and may be any apparatus as long as the apparatus requires genre conception or determination. For example, a TV or a set-top box may distinguish or recognize a program of a specific genre from image content input from an external source online and for example, may further distinguish an advertisement and so on. In addition, a BD player may distinguish an advertisement from content stored in a BD inserted offline. For example, the image processing apparatus 100 may distinguish various genres such as News, sports, animation, music, drama, and so on, as illustrated in FIG. 2.

The genre conception may be used by the image processing apparatus 100 via various methods.

First, the genre conception may be used to enhance video of a specific genre. In other words, a TV as a well as movie equipment may include a genre detection module, for a series of specific genre video enhancement modes installed to automatically select an appropriate mode, that is, a setting filter or another setting.

In addition, the image processing apparatus 100 may perform a smart channel browsing operation. Users may specify a genre (genre preference) preferred by them in advance or prior to a search, may permit channel scan, and then may automatically skip an unwanted genre program from currently broadcast channels until a preferred genre of a first program is retrieved. In this case, when the user is given a chance of continuously watching a selected channel or permitting a channel browsing mode, the automatic channel skip may be stopped.

Furthermore, selective video recording may also be enabled. The user may want to record only a genre or type of video stream. For example, during broadcast of a soccer game, only game content may be actually recorded without intermissions, advertisement, interview, and so on.

Mobile apparatuses may enable intelligent personalized (or customized) classification of media content. The user may want to use the classification in order to automatically conceive a genre of media in real time and store information items classified in sub folders corresponding to the genre.

Mood media classification may be possible. In this case, when the user is capable of monitoring some media contents in real time, the image processing apparatus 100 may set mood labeling for content parts (or pieces) after an analysis step.

Object detection may also be possible. The image processing apparatus 100 according to an embodiment may individually (or separately) other applications detect objects through a feature detection module. For example, one of feature detection module for searching and detecting an object may detect a text/logo, and so on in order to provide more information items for user interest.

Detection of advertisement parts may be possible. For example, channels may be changed in response to an advertisement starting to play. In addition, in response to an advertisement being detected, sound may be disabled. Furthermore, an audio signal may be set in response to an advertisement being finished.

Parental control may be possible. Unacceptable contents for children, such as horror or thriller content may be set to be disabled. For example, when a parent wants to set limits to a specific genre of content so as to limit content that children watch, reception of the set genre of content may be limited before the setting is released.

Anonymous statistical collection for TV channel estimation may be possible. For TV channel estimation for determination of a most popular genre and a genre that has been watched for a predetermined time period, anonymous statistical collection may be possible. In other words, the image processing apparatus 100 may provide data about channel popularity estimation together with apparatus information of the image processing apparatus 100 to a service provider when genre detection is finished or even if genre detection is detected.

In addition, statistical collection for user interest may be possible. The statistical collection may be used to propose some media content, that is, a TV program based on previous statistics or to use the media contents for other applications.

Furthermore, any apparatus may be personalized. In other words, an ability of selecting inappropriate video/media parts for the user and learning a system therefor, that is, the image processing apparatus 100 based on the selection may be provided.

In order to perform this function, the image processing apparatus 100 according to an embodiment detects a genre of a video stream without significant delay or access (or approach) with respect to entire film footage of a video program to be classified. For example, after a frame is updated at every time point (from a time point) when a feature vector as feature information is present, current appropriate genre information may be obtained with reference to the vector. In this case, a video genre may be detected based on video features for describing (or stating) color, texture, motion feature, and textual and object contents present in a video frame.

According to an embodiment, the aforementioned operations may be performed using genres conceived by various components such as a video processor, a tuner, and a controller. In addition, the genre conception system 90 may further include various components such as an information collector or an information analyzer.

Performance of the image processing apparatus 100 according to an embodiment may be estimated relatively or as compared with conventional technology in terms of two aspects. Speed and quality of genre detection correspond to the aspects. Speed of extraction of the features of frames constituting the video stream may not exceed actual time as well a as time required to classify the video stream. This classification speed may be measured in a second unit or a frame number unit, which is required to detect a genre.

With regard to performance estimation, measurement for all systems, i.e., apparatuses need to be tested with the same data set, which is always disabled due to lack of access to the apparatus or the tested data set, and thus it is difficult to compare the image processing apparatus 100 according to an embodiment with a counterpart. When this possibility is present, performance may be estimated according to accuracy and recall conditions. In addition, other features to be considered during comparison may include features about whether whole video is required to determine a genre thereof, features about shapes/groups of the features, used to ensure genre conception, time required to acquire a classification result after video is begun/genre is changed, features about whether a list of conceived genre is changed, expanded, or narrowly reduced, the amount of data required for training, and so on.

The image processing apparatus 100 according to an embodiment may operate in two main modes. For example, the modes may include a training mode and a working mode. Needless to say, an important pre-requisite for training accurate models is a representative data set that includes all genres of videos that need to be classified by the image processing apparatus 100. Although the principle and rule for designing and generating (or creating) a data set exceed the range of the embodiments and thus will not be described, it is crucial that the data set needs to be representative. According to an embodiment, the image processing apparatus 100 may perform at least one of training and working operations.

The image processing apparatus 100 according to an embodiment may perform the following operation during training. First, a video data set may be processed. In the current operation for each shot of raw video contents (or video files), feature vectors are stored. For example, the feature vectors may be stored in a cache. Here, the cache may be a small-sized high speed memory used to enhance performance and may be a portion of a main memory unit used for the same purpose. The feature vector includes numbers of values associated with image features and a genre label of a current shot or frame. These values may be generated by feature calculating modules. In addition, the image processing apparatus 100 may perform a feature selection operation in a training mode. In other words, when processing time needs to be further reduced or custom-tailoring of genre specifying modules is necessary according to a command, various strategies or plans of feature selection may be used. Furthermore, the image processing apparatus 100 may perform feature engineering and data preprocessing operations. To this end, data instances may be processed via principal component analysis (PCA) in order to convert a feature space into a new space and may be clustered using a K-means scheme for optimum representative instances for model training. In addition, the image processing apparatus 100 may perform model training and test operations. As such, for example, it may be possible to select an optimum model for each genre.

In a working mode, the image processing apparatus 100 may perform the following operation. First, a video stream is received. In addition, a pre-trained model is received. This model may be provided online as necessary and may also be configured in the form of a program that is pre-stored offline. In addition, a feature vector for each frame includes feature vectors calculated by specific modules. For example, a feature vector may be stored at a predetermined time period or interval of 2 seconds. The stored vector may be classified by a classifier. The classification result is returned. That is, the classification result may be repeatedly stored and classified.

The communication network 110 includes both wired and wireless communication networks. Here, the wired communication network is interpreted as including the Internet such as a cable network or a public switched telephone network (PSTN) and the wireless communication network is interpreted as including CDMA, WCDMA, GSM, evolved packet core (EPC), long term evolution (LTE), a Wibro network, and so on. Accordingly, when the communication network 110 is a wired communication network, an access point may access a switching center of a telephone office, but when the communication network 110 is a wireless communication network, an access point may access an SGSN or a gateway GPRS support node (GGSN) which is managed by a telecommunication company and process data or may access various relays such as base station transmission (BTS), NodeB, e-NodeB, and so on and process data.

The communication network 110 includes a small base station (AP) such as a femto or pico base station that is largely installed in a building. Here, the femto or pico base station is classified based on a maximum number of image processing apparatuses 100 that the base station accesses according to classification of a small base station. Needless to say, the AP includes the image processing apparatus 100 and a local area communication module for performing local area communication, such as Zigbee and Wi-Fi. According to an embodiment, local area communication may be performed according to various standards such as Bluetooth, Zigbee, Infrared ray (IrDA), radio frequency (RF) such as ultra high frequency (UHF) and very high frequency (VHF), and ultra wide band communication (UWB) as well as Wi-Fi. Accordingly, the AP extracts a position of a data packet, determines an optimum communication path of the extracted position, and transmits the data packet to a next apparatus, for example, the image processing apparatus 100 along the determined communication path.

The content providing apparatus 120 may include, for example, a broadcasting server managed by a broadcasting station. Alternatively, even if the content providing apparatus 120 is not a broadcasting station, the content providing apparatus 120 may include a server of a content image provider for providing various content.

The interface apparatus may be a set-top box when the image processing apparatus 100 includes a TV and so on. When the image processing apparatus 100 is a set-top box, the interface apparatus may be a VCR, a BD reproducer, or the like. In other words, the interface apparatus may be various content sources for providing content to the image processing apparatus 100 offline.

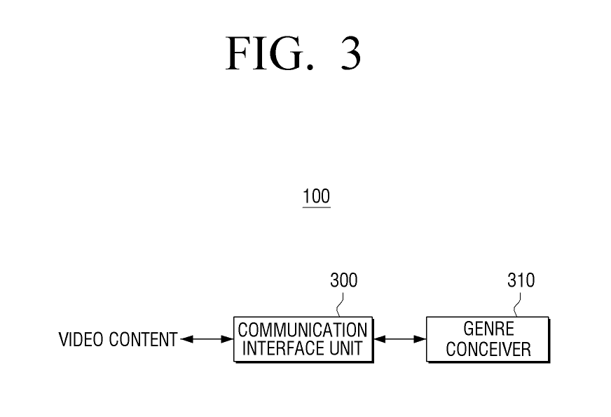

FIG. 3 is a block diagram illustrating the image processing apparatus 100 of FIG. 1.

As illustrated in FIG. 3, the image processing apparatus 100 of FIG. 1 according to an embodiment may include some or all of a communication interface unit 300 and a genre conceiver 310.

Here, the expression ‘inclusion of some or all’ means that the communication interface unit 300 may be omitted or integrated with the genre conceiver 310, and it is assumed that the image processing apparatus 100 includes all the components to gain a sufficient understanding of the embodiments.

The communication interface unit 300 receives (or loads) video content. Here, the video content may be interpreted as referring to a plurality of still images. Needless to say, the communication interface unit 300 may receive various video contents online/offline and may receive metadata together during this process. In this case, various operations of separating video content and metadata and decoding the separated video content may be further performed to generate a new video stream. Needless to say, the decoding process is performed under the assumption in that video content is compressed. Accordingly, when video content is received in a non-compressed state, the decoding process may not be necessary. In general, in the case of online content, when video content is provided in a compressed state, the video content may be received offline in a non-compressed state.

The genre conceiver 310 conceives (or recognizes or determines or detects) a genre of the received video content. To this end, for example, feature information may be extracted with respect to an initially input unit frame, and feature information may be detected every frame based on the feature information detected for unit frame. For example, various feature information items such as the aforementioned color, motion information, and edge information through a unit frame. The genre conceiver 310 may compare these features with features of a previous frame to conceive a genre. For example, when there is a remarkable change between a previous frame and a current frame via comparison of feature vectors or when parameters or values associated with vectors exceed a preset value, the genre may be conceived to be changed.

During this process, the genre conceiver 310 may check or detect whether there is shot break or break between a previous frame and a current frame and may necessarily store feature vectors in, for example, a cache when there is shot break as the check result. Needless to say, even if there is no shot break, feature vectors for frames may be detected and stored at a frequency corresponding to a predetermined period of time. When the stored vectors are used in a training mode, all the stored vectors may be stored in separated files and these files may be used for data preprocessing and model training in the future.

The genre conceiver 310 may generate statistical data. For example, it may be possible to perform an operation of determining whether a user prefers or skips a specific genre and analyzing a genre that is preferred or skipped in a predetermined time zone to generate analysis data.

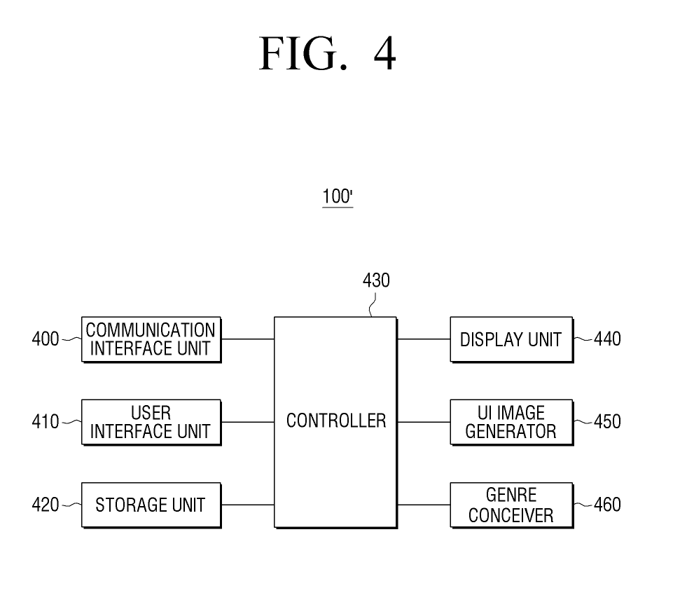

FIG. 4 is a block diagram illustrating another structure of the image processing apparatus of FIG. 1.

As illustrated in FIG. 4, an image processing apparatus 100′ may be an image displaying apparatus including a display unit that is capable of displaying an image, such as a TV or a cellular phone, and may include some or all of a communication interface unit 400, a user interface unit 410, a storage unit 420, a controller 430, a display unit 440, a UI (user interface) image generator 450, and a genre conceiver 460.

Here, the expression ‘inclusion of some or all’ means that some component such as the display unit 440 may be omitted or some components such as the storage unit 420 or the genre conceiver 460 may be integrated with a component such as the controller 430, and it is assumed that the image processing apparatus 100′ includes all the components to gain a sufficient understanding of the embodiments.

The communication interface unit 400 and the genre conceiver 460 illustrated in FIG. 4 are not much different from the communication interface unit 300 and the genre conceiver 310 illustrated in FIG. 3, and thus a detailed description of the communication interface unit 400 and the genre conceiver 460 will be replaced with the detailed description in FIG. 3. However, the genre conceiver 460 of FIG. 4 may be different from the genre conceiver 310 of FIG. 3 in that the genre conceiver 460 is operated under control of the controller 430, which may be a computer.

The user interface unit 410 may receive various user commands. For example, according to a user command of the user interface unit 410, the controller 430 may display a UI image for setting various information items on the display unit 440. For example, a user command for various setting operations of setting a genre that needs the aforementioned parent control may be input through the user interface unit 410. Substantially, the UI image may be provided by the UI image generator 450 according to control of the controller 430.

The storage unit 420 may store various data or information items that are processed by the image processing apparatus 100 and store various feature information items that are detected by the genre conceiver 460 or classified. In addition, when the storage unit 420 is a cache, the storage unit 420 may be formed in the controller 430 as a portion thereof.

The controller 430 controls an overall operation of the communication interface unit 400, the user interface unit 410, the storage unit 420, the display unit 440, the UI image generator 450, and the genre conceiver 460, which are included in the image processing apparatus 100′. For example, in response to video content being received through the communication interface unit 400, the controller 430 may transmit the video content to the genre conceiver 460. In this process, when the communication interface unit 400 separates metadata as additional information and provides a decoded file to the controller 430, the controller 430 may transmit the file. Needless to say, when video content is provided via a HDMI method, the video content may be transmitted in a non-compressed state. In addition, the controller 430 may store feature information detected by the genre conceiver 460 in the storage unit 420 and control the UI image generator 450 to display a UI image on the display unit 440 in response to a user request being received.

The display unit 440 may display an UI image provided by the UI image generator 450 according to a user request, and various setting operations of the user may be performed through the displayed UI image. For example, when the user wants to skip advertisements, the controller 430 may abandon or drop a frame corresponding to the advertisement conceived by the genre conceiver 460. In addition, the display unit 440 may display various information items desired by the user. For example, when the user requests specific information such as a delete list, it may be possible to display the delete list.

The UI image generator 450 may also be referred to as a UI image provider. In response to a user request being received, the UI image generator 450 may generate a UI image or output an UI image that is generated and pre-stored.

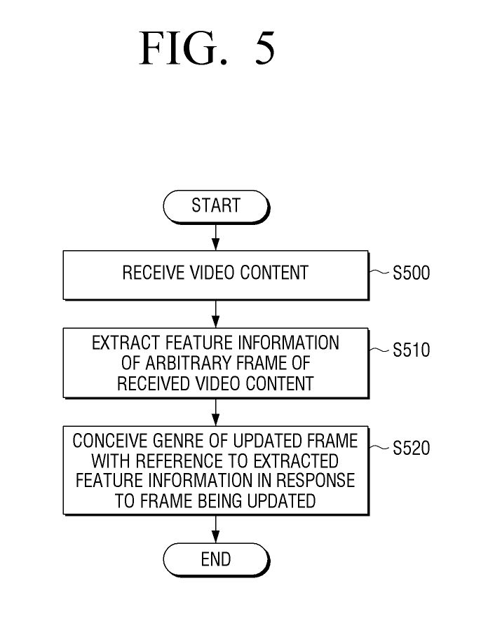

FIG. 5 is a flowchart illustrating an image processing method according to an embodiment.

For convenience of description, with reference to FIG. 5 together with FIG. 1, the image processing apparatus 100 according to an embodiment receives video content online/offline (S500). In this case, the video content may be provided via a compression/non-compression method and received together with metadata as additional information. In this process, the image processing apparatus 100 may decode the compressed video content or separate the metadata.

Then, the image processing apparatus 100 may extract and detect feature information of an arbitrary frame of the received video content (S510). Feature information of an initial frame of the video content may be detected.

In addition, in response to each frame being updated, the image processing apparatus 100 may conceive a genre of the updated frame with reference to the detected feature information (S520). In this case, the updated frame may be determined according to the number of frames and determined at a frequency corresponding to a predetermined period of time. For example, when the predetermined period of time is set as 2 seconds, the image processing apparatus 100 may determine a genre every two seconds and determine whether the genre is changed. In this case, the image processing apparatus 100 may detect a change in genre by detecting feature information of an initial frame at a frequency corresponding to 2 seconds and comparing the detected feature information items. In addition, when a genre is determined according to the number of frames, a change in genre may be determined every 5 frames or 10 frames. In this case, the change in genre may also be conceived by detecting and comparing feature information items, i.e., features vectors of an initial frame.

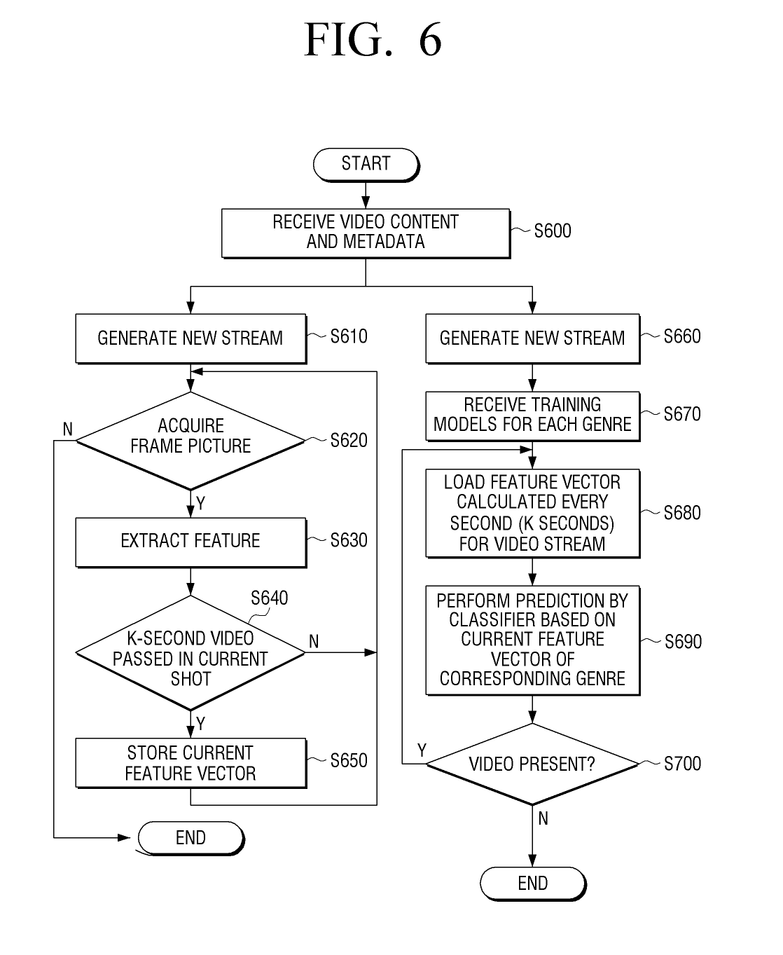

FIG. 6 is a flowchart illustrating an image processing method according to another embodiment.

For convenience of description, with reference to FIG. 6 together with FIG. 1, the image processing apparatus 100 according to an embodiment may be configured to be operated in at least one of a training mode and a working mode. In other words, the image processing apparatus 100 may be configured to execute only the training mode or to execute only the working mode or configured to perform an operation only in one of the two modes according to mode setting of a user. Accordingly, the image processing apparatus 100 may also be referred to as an image test apparatus.

In order to perform a training operation, the image processing apparatus 100 may receive video content and metadata (S600).

Then, the image processing apparatus 100 may separate the metadata from the video content, and when the video content is compressed, the image processing apparatus 100 may decode the video content to generate a new video stream (S610).

A frame image or picture, i.e., a unit frame image is acquired from the newly generated stream (S620). This process may be checked through additional information indicating a beginning and an end of, for example, a unit frame.

The image processing apparatus 100 extracts features from the acquired frame image (S630). That is, feature information is extracted.

In addition, the feature information is extracted with respect to video with a unit of K seconds, which are passed in a current shot (S640). Although the feature information is extracted with respect to all frames with a unit of K seconds, the feature information may be extracted with respect to only an initial frame.

Then, a current feature vector may be stored (S650). For example, the current feature vector may be stored in, for example, a cache.

In a working mode, the image processing apparatus 100 may receive video content and metadata similarly to a training mode and generate a new stream from the received video content (S600, S610).

Then, the image processing apparatus 100 may receive, for example, a program based on an optimum model obtained via a training process (S670). The program may be directly received online but may be pre-stored offline. Here, the model may be a model such as a SVM or the like or may have the form of a program.

In addition, the image processing apparatus 100 loads or stores feature vectors that are calculated using the received model, that is, are calculated every K seconds (S680).

In addition, a classifier of the image processing apparatus 100 may perform prediction based on a current feature vector of a corresponding genre (S690).

Then, the image processing apparatus 100 further determines whether video is present, repeatedly performs operations S680 and S690 in units of K seconds when video is present, and terminates the operations when there is no video (S700).

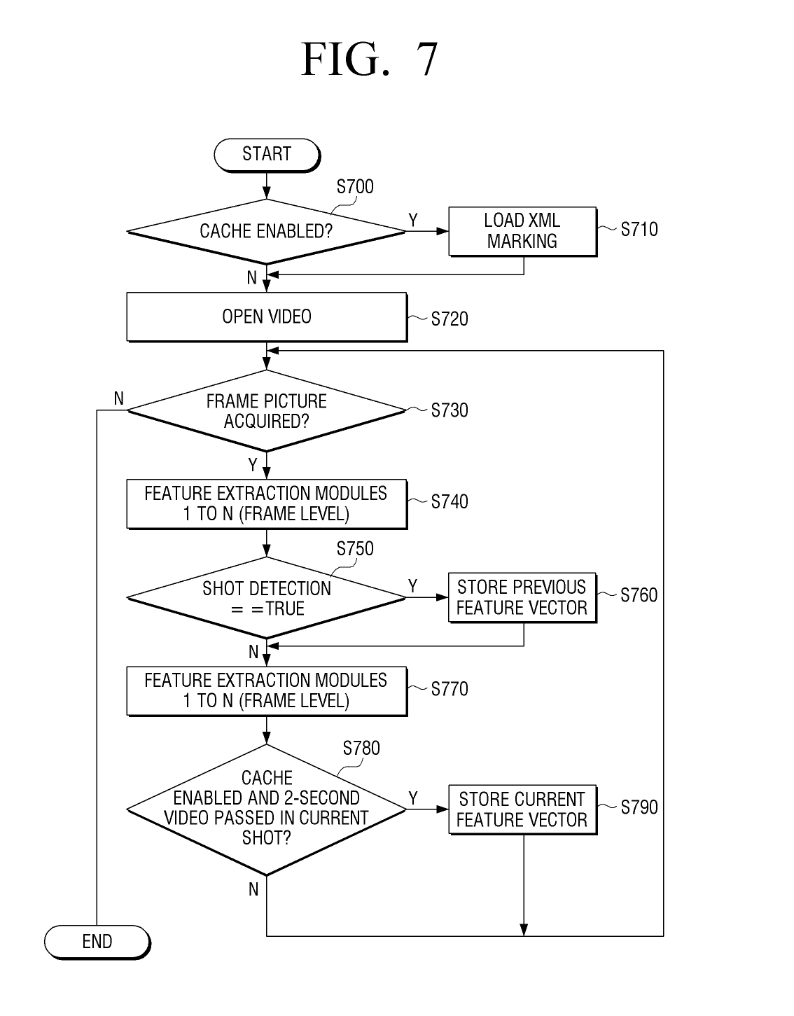

FIG. 7 is a flowchart illustrating the feature extraction process of FIG. 6 in more detail.

Overall system design of the image processing apparatus 100 according to an embodiment is based on target genres that are dependent upon only availability of training content, but not on a specific genre. A training process includes feature extraction, feature engineering, data preprocessing, and model training processes. Among these, the feature extraction process is illustrated in FIG. 7.

For convenience of description, with reference to FIG. 7 together with FIG. 1, the image processing apparatus 100 according to an embodiment may determine whether a cache, i.e., a storage unit for storing the extracted feature is in an enable state, in the feature extraction process (S700).

When the cache is in an enable state, the image processing apparatus 100 may receive XML marking (S710). For example, XML marking or marking information may be acquired from the enabled cache.

Then, the image processing apparatus 100 opens the video (S720).

Then, a frame image is acquired from the opened video (S730). In this regard, the sufficient description has been given before, and thus a detailed description thereof will be omitted.

The image processing apparatus 100 extracts features of a frame image using a plurality of feature detection modules (S740).

When shot detection is appropriately performed, extracted previous feature vectors are stored (S750 and S760).

When shot detection is not appropriately performed based on the extracted features, the feature extraction process may be re-performed (or performed again) using a plurality of feature detection modules (S750 and S770).

In addition, when a storage unit, such as a cache, is enabled and 2-second video is passed in a current shot, a current feature vector is stored in the cache (S780 and S790).

When a condition of operation S780 is not satisfied, in other words, when 2 seconds are not satisfied or storage of 2-second video is terminated, a feature of a new video frame may be detected and operations S730 to S770 may be repeatedly performed.

In summary, video from a non-processed data set is opened and features are extracted from each frame by specified feature extraction modules. All values acquired by the feature extraction modules are stored in a feature vector. During frame processing, a shot detection module or detects whether there is a shot break between a current frame and a previous frame. Whenever a shot break occurs, the current feature vector is cached or stored as an instance for future training. When there is no registered shot break, if a predetermined period of time elapses after a previous feature vector is cached, the current feature vector is also cached. All video contents from the data set may be processed, all the cached vectors may be stored in separated files, and the files will be used for data preprocessing and model training.

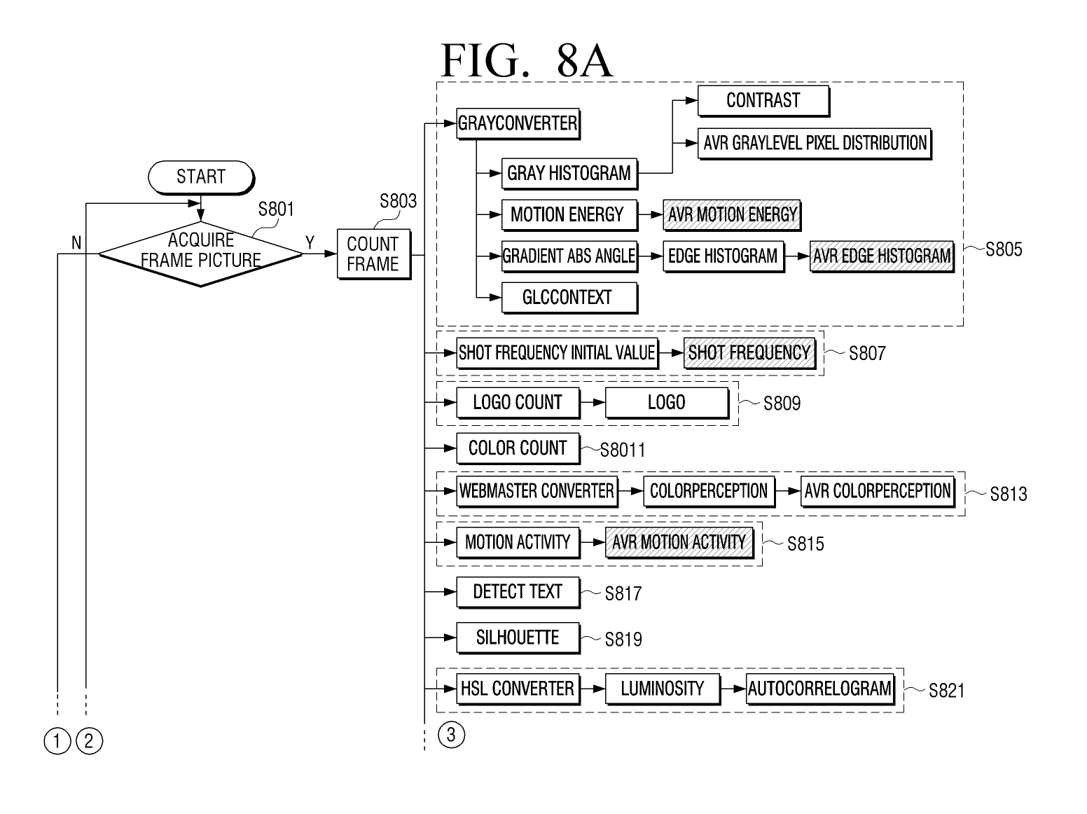

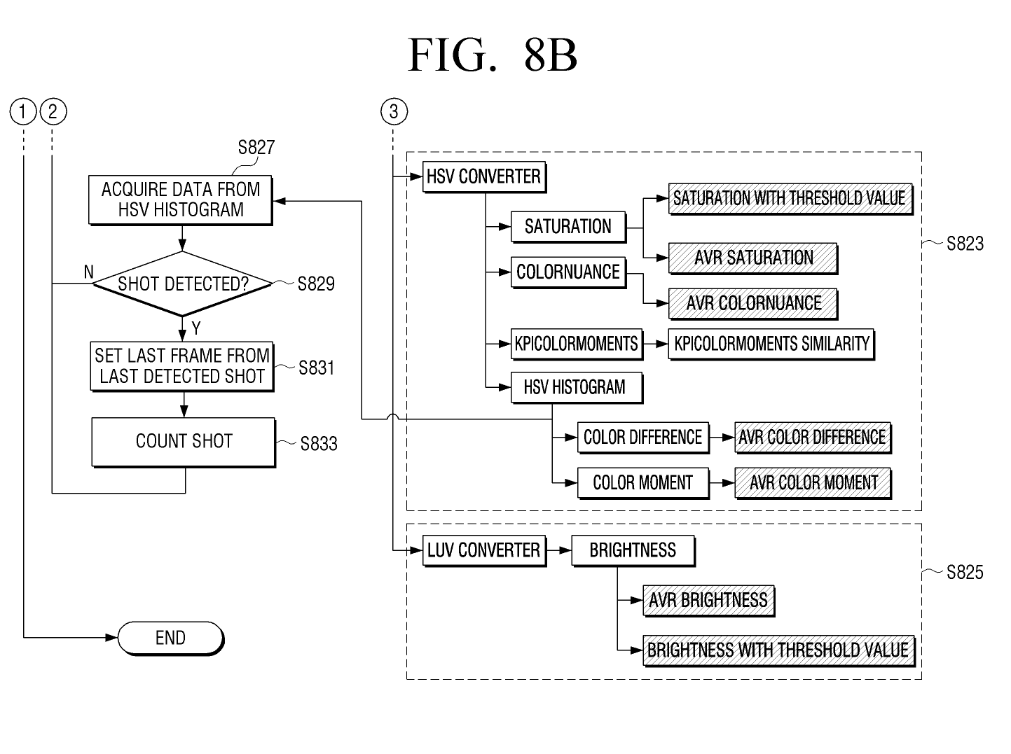

FIGS. 8A and 8B are flowcharts illustrating detailed operations of the feature extraction modules illustrated in FIG. 7. For reference, FIGS. 8A and 8B correspond to one diagram obtained by connecting numbers \textcircled{1}, \textcircled{2}, and \textcircled{3} of FIG. 8A to them of FIG. 8B. In addition, in FIGS. 8A and 8B, shaded feature extraction modules are associated with shot processing and the remaining parts are associated with frame processing.

For convenience of description, with reference to FIGS. 8A and 8B together with FIG. 1, the image processing apparatus 100 according to an embodiment may acquire a frame picture and count frames (S801 and S803). For example, when setting is performed according to the number of frames, this operation may be performed.

Then feature detection is performed on an initial frame or all frames among the counted frames (S805 to S825). This operation may be performed on the same frame using a detection module for detecting various features.

For example, although feature detection is illustrated in FIG. 8 in detail, feature detection such as grayconverter for acquisition of contrast, gray histogram, motion energy, edge histogram, and GLCcontext may be representatively performed. In other words, R, G, and B images of a unit frame may be expressed in a 0 to 255 gray scale, and thus a conversion process for this is required. As such, various operations of operation S805 may be performed.

In addition, various operations for acquisition of features such as shot frequency, logo, color count, colorperception, motion activity, text detection, silhouette, and so on may be performed.

In addition, an operation for converting color coordinates of R, G, and B of a unit frame may be performed. For example, HSL, HSV, and LUV conversion may be performed. After the color coordinates conversion process, various wanted feature information items may be extracted according to an embodiment.

For example, features such as luminosity, autocorrelogram, and so on may be acquired through HSLconverter, saturation, colornuance, KPIcolormoments, and HSV histogram may be acquired through HSVconverter, and brightness and so on may be acquired through LUVconverter.

However, the image processing apparatus 100 may acquire data from the HSV histogram obtained in operation S823 (S827).

In addition, a shot detection process is performed through the acquired data, a last frame in which a shot is detected is set or determined, and then shots may be counted (S829 S833). Here, the shot counting may be interpreted as counting frame number of specific shot or counting shot number.

Although all elements constituting the embodiments are described as integrated into a single one or to be operated as a single one, the embodiments are not necessarily limited to such embodiments. According to embodiments, all of the elements may be selectively integrated into one or more and be operated as one or more within the object and the scope of the embodiments. Each of the elements may be implemented as independent hardware. Alternatively, some or all of the elements may be selectively combined into a computer program having a program module performing some or all functions combined in one or more pieces of hardware. A plurality of codes and code segments constituting the computer program may be easily understood by those skilled in the art to which the embodiments pertain. The computer program may be stored in non-transitory computer readable media such that the computer program is read and executed by a computer to implement embodiments.

The non-transitory computer readable medium is a medium that semi-permanently stores data and from which data is readable by a device, but not a medium that stores data for a short time, such as register, a cache, a memory, and the like. In detail, the aforementioned various applications or programs may be stored in the non-transitory computer readable medium, for example, a compact disc (CD), a digital versatile disc (DVD), a hard disc, a bluray disc, a universal serial bus (USB), a memory card, a read only memory (ROM), and the like, and may be provided.

The foregoing exemplary embodiments and advantages are merely exemplary and are not to be construed as limiting the embodiments. Also, the description of the exemplary embodiments is intended to be illustrative, and not to limit the scope of the claims, and many alternatives, modifications, and variations will be apparent to those skilled in the art.

Although a few embodiments have been shown and described, it would be appreciated by those skilled in the art that changes may be made in these embodiments without departing from the principles and spirit of the embodiments, the scope of which is defined in the claims and their equivalents.

What is claimed is:

1. An image processing apparatus, comprising:
a communication interface unit configured to receive video content; and
a genre conceiver configured to extract feature information of an arbitrary frame of received video content and to conceive a genre of an updated frame with reference to extracted feature information in response to the arbitrary frame being updated.

2. The image processing apparatus as claimed in claim 1, further comprising a user interface unit configured to set at least one user information for searching for, storing, skipping, and watch-limiting data corresponding to a conceived genre, wherein the genre conceiver processes the video content based on set user information and the conceived genre.

3. The image processing apparatus as claimed in claim 1, wherein the genre conceiver conceives the genre based on at least one feature information of color, texture, motion feature and edge feature of the frame, and textural and object content present in a video frame.

4. The image processing apparatus as claimed in claim 1, wherein the genre conceiver comprises a detector configured to detect whether there is a break between a previous frame and a current frame, and in response to the break occurring as a detection result, stores feature information of the current frame.

5. The image processing apparatus as claimed in claim 4, wherein the genre conceiver stores the feature information of the current frame at a period corresponding to a predetermined interval of time when there is no break between the current frame and the previous frame.

6. The image processing apparatus as claimed in claim 1, further comprising a storage unit, wherein the genre conceiver detects feature information of the updated frame, separates detected feature information, and stores separated feature information in the storage unit.

7. The image processing apparatus as claimed in claim 1, wherein:
the genre conceiver comprises a plurality of feature information detectors configured to respectively detect a plurality of feature information with different features; and
the plurality of feature information detectors comprise a model selected by a training process for searching for a model appropriate for genre detection.

8. The image processing apparatus as claimed in claim 7, wherein the genre conceiver is operated in a training mode for the training process, processes data instances of a video data set of the video content by principle component analysis (PCA) in the training mode, and searches for an appropriate model by using a K-means scheme for representative instances for model training and by clustering the representative instances.

9. The image processing apparatus as claimed in claim 1, further comprising a video processor configured to enhance video of a conceived genre.

10. The image processing apparatus as claimed in claim 1, further comprising a tuner configured to automatically skip a channel until a channel of a conceived genre is retrieved.

11. The image processing apparatus as claimed in claim 1, further comprising a controller configured to one of limit recording and limiting watching an image of a conceived genre.

12. An image processing method, comprising:
receiving video content;
extracting feature information of an arbitrary frame of received video content; and
conceiving a genre of an updated frame with reference to extracted feature information in response to the arbitrary frame being updated.

13. The image processing method as claimed in claim 12, further comprising:
setting at least one user information for searching for, storing, skipping, and watch-limiting data corresponding to a conceived genre; and
processing the video content based on set user information and the conceived genre.

14. The image processing method as claimed in claim 12, wherein the conceiving comprises conceiving the genre based on at least one feature information of color, texture, motion feature and edge feature of the frame, and textural and object content present in a video frame.

15. The image processing method as claimed in claim 12, wherein the conceiving comprises detecting whether there is a break between a previous frame and a current frame, and in response to the break occurring as a detection result, storing feature information of the current frame.

16. The image processing method as claimed in claim 15, wherein the conceiving comprises storing the feature information of the current frame at a period corresponding to a predetermined interval of time when there is no break between the current frame and the previous frame.

17. The image processing method as claimed in claim 12, wherein the conceiving comprises;
detecting feature information of the updated frame; and
separating detected feature information and storing separated feature information in a storage unit.

18. The image processing method as claimed in claim 12, wherein:
the conceiving comprises respectively detecting a plurality of feature information with different features; and
a plurality of detected feature information are detected by embodying a model selected by a training process for searching for a model appropriate for genre detection.

19. The image processing method as claimed in claim 18, wherein:
the conceiving is operated in a training mode for the training process, and comprises processing data instances of a video data set of the video content by principle component analysis (PCA) in the training mode, and using a K-means scheme for representative instances for model training to search for an appropriate model and clustering the representative instances.

20. A non-transitory computer readable recording medium having a program for executing an image processing method, the method comprising:
receiving video content;
extracting feature information of an arbitrary frame of received video content; and
conceiving a genre of an updated frame with reference to extracted feature information in response to the arbitrary frame being updated.
